(19) United States
(12) Patent Application Publication
(10) Pub. No.: US 2023/0321934 A1
(43) Pub. Date: Oct. 12, 2023

(54) METHOD OF MAKING OPEN-ENDED THERMOPLASTIC BELTING

(71) Applicant: Charles YOUNG, Osterville, MA (US)

(72) Inventor: Charles YOUNG, Osterville, MA (US)

(21) Appl. No.: 18/178,137

(22) Filed: Mar. 3, 2023

Related U.S. Application Data
(60) Provisional application No. 63/328,490, filed on Apr. 7, 2022.

(51) Int. Cl. B29D 29/06

(52) U.S. Cl. CPC B29D 29/06; B29K 2075/00

(57) ABSTRACT

A system and method of making an open-ended layered thermoplastic food conveyor belt having a profile layer, a top layer, and tensile cords fully encapsulated there between. The method includes engaging a portion of a top thermoplastic layer on a rotatable cylindrical mandrel laying a plurality of tension cords on top of this layer in the machine direction and applying or extruding a second layer of thermoplastic matrix.

### BACKGROUND OF THE INVENTION

### Field of the Invention

This invention relates generally to a system for making open-ended belting having several advantages over both monolithic (resin only) food conveyor belts and two-pass food belts where the cord is embedded in one layer during the first pass of the manufacturing process.

### Description of the Prior Art

Food conveyor belt constructions have progressed over time from flat nitrile rubber belts through the 1970s, to plastic injection molded modular plastic belts in the 1980s, to monolithic urethane belts in the early 2000s, to urethane belts embedded with a cord or some other tension members in the 2010s. Each new development addressed a particular shortcoming in prior belt constructions but still left the food conveyor belt installer with other and new challenges. In the case of the monolithic belt made from single extrusion pass, as disclosed in U.S. Pat. No. 7,210,573 B2 to Mol Industries, the belt offers significant cleaning advantages over the plastic modular belt construction. However, in the absence of any tension member, the belt would eventually stretch, over time, requiring fabricator service calls in order to shorten the belt length.

More recent belt constructions, include international patent WO 2017/017137 A1 to Habasit (“Habasit”) and U.S. Pat. No. 8,668,799 to Gates Corporation (“Gates”), introduced embedded cord/tension members in order to reduce stretch and while allowing for a lower durometer, less stiff resin. The Habasit reference centers around a single-pass extrusion process while the Gates patent is based on a two-pass extrusion process where the tension cords are embedded in the first pass. The Gates patent involves embedding the tension cord in the bottom layer (the drive or tooth side of a positive-driven belt). Having the cord in the first pass creates potential slitting problems due to the side-to-side variation as the first pass web is unwound and fed to the first nip point for the second extrusion and the fact that the embedded cord is not visible to the operator. The distance specification from the outside cord to the belt edge is typically 0.5 inches. Given the side-to-side movement of the first web and the fact that the operator can't see the cord, there is a high probability that the most outside cord on the belt can be exposed by the trim knives that create the finished belt edge. Once exposed, the tension cord then becomes a harbor point for bacteria and the belt must be rejected and replaced.

### SUMMARY OF THE INVENTION

Wherefore, it is an object of the present invention to overcome the above mentioned shortcomings and drawbacks associated with the prior art.

### BRIEF DESCRIPTION OF THE DRAWINGS

The accompanying drawings, which are incorporated in and constitute a part of the specification, illustrate various embodiments of the invention and together with the general description of the invention given above and the detailed description of the drawings given below, serve to explain the principles of the invention. The invention will now be described, by way of example, with reference to the accompanying drawings in which:

FIG. 1 is a diagrammatic view showing the first pass process according to the disclosure; and

FIG. 2 is a diagrammatic view showing the second pass process according to the disclosure; and

FIG. 3 is a diagrammatic view showing the first pass roller apparatus and the second pass roller apparatus which are sequentially arranged, one after the other, to form the food conveyor belt during a single production operation according to the disclosure.

It should be understood that the drawings are not necessarily to scale. In certain instances, details which are not necessary for an understanding of this disclosure or which render other details difficult to perceive may have been omitted. It should be understood, of course, that this disclosure is not limited to the particular embodiments illustrated herein.

### DETAIL DESCRIPTION OF THE PREFERRED EMBODIMENT(S)

The present invention will be understood by reference to the following detailed description, which should be read in conjunction with the appended drawings. It is to be appreciated that the following detailed description of various embodiments is by way of example only and is not meant to limit, in any way, the scope of the present invention.

The invention provides a method to manufacture open ended profile or flat belts made up of two or more layers of elastomeric matrix with tension cords embedded in the middle of the composite. The belt itself has a top surface substantially free of any discontinuities and a bottom surface with a plurality of teeth extending therefrom at a given belt pitch. This top or exposed outside surface, of the food conveyor belt, is the carrying surface for the food transport. Conventional processes of continuous extrusion-forming of thermoplastic elastomer or thermoplastic urethane belt profiles, consisting of one or more different elastomers, can be coextruded utilizing a rotatable molding wheel which is supplied with a molding band (usually of flexible steel) wrapping around about half of the circumference of the molding wheel to form a rotating molding chamber. In addition to coextrusion, the manufacture of the belt can be from made from several manufacturing processes—tandem extrusion, two pass extrusion and lamination.

The elastomeric matrix can be a thermoplastic polyurethane (TPU) or any other suitable thermoplastic elastomer (TPE). The matrix may be a combination of materials, such as a blend. The matrix material(s) may include any number of desirable ingredients, including for example, anti-oxidants, anti-ozonants, UV stabilizers, anti-microbial additives, process aids, softeners, fillers, friction modifiers, foamers, and the like. The properties of each elastomer are purposely different. The tension members may or may not be coated with an adhesive or other covering.

Accordingly, the appended claims are intended to include within their scope such processes, machines, manufacture, compositions of matter, means, methods, and/or steps. The invention disclosed herein may suitably be practiced in the absence of any element that is not specifically disclosed herein.

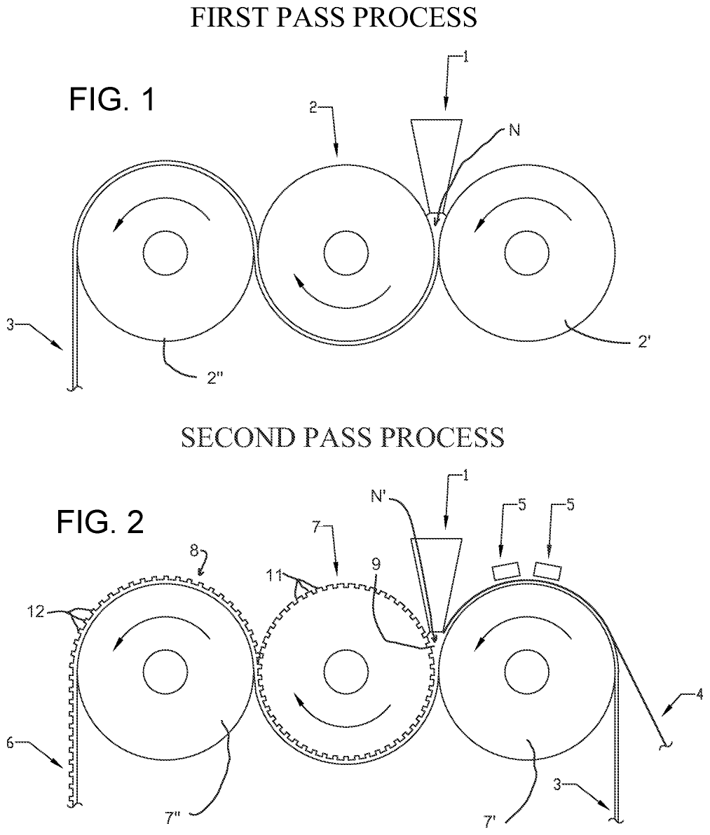

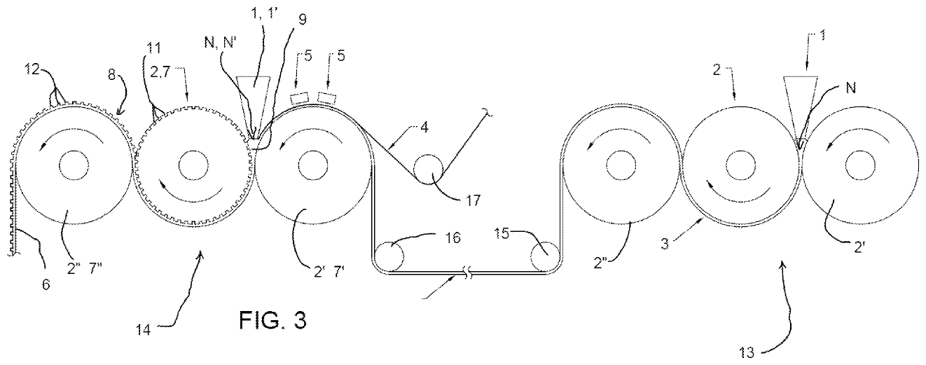

According to one embodiment shown in FIG. 1, during the first pass manufacturing process, the first (food carrying) layer comprises a flat sheet 3 which is typically manufactured or made from a urethane resin, typically having a 85 to 98 Shore A hardness. The material for forming the first (food carrying) layer is extruded through a (first) die nozzle 1 and then passing through a first nip N point formed between first (feed) and second (mandrel) adjacent rollers 2′, 2 rotating in rotational directions opposite to one another. The urethane resin is typically discharged from the die nozzle 1 at a temperature of between 350 and 600 degrees Fahrenheit. One or both of the first and the second adjacent rollers 2′, 2 are controlled to a temperature of between 50 and 250 degrees Fahrenheit to assist with cooling and formation of the flat sheet 3. The outwardly facing surface of the first (feed) roller 2′ is typically spaced from the outwardly facing surface of the second (mandrel) roller 2 by a distance of between 0.010 inches and 0.50 inches so that the (first) nip N′ normally has a gap or width of between 0.010 inches and 0.50 inches. The formed flat sheet 3 is then transferred to a transfer roller 2″ which provides additional dwell time and assists with further cooling and formation of the formed flat sheet 3. Finally, the manufactured flat sheet 3 may be rolled up off the transfer roller 2″ on to a conventional winder (not shown), in a conventional manner, or possibly may be feed directly to the second pass manufacturing process (see FIG. 3), described below, for formation of the food conveyor belt 6 which comprises two or more layers of different elastomers with at least one cord(s) 4 sandwiched between the two outer layers thereof.

The first and the second adjacent rollers 2, 2′ and the transfer roller 2″ each have a diameter of about 16 inches or so and rotate at a rotation speed of between 10 and 200 inches per minute during manufacture of the flat sheet 3. In the event that the flat sheet 3, the bottom surface 8 and the food conveyor belt 6 are all to be manufactured on the one and the same roller apparatus, then, prior to commencing the second pass manufacturing process, the smooth cylindrical second (mandrel) roller 2 is replaced with the (second) forming mandrel/roller 7, having a plurality of teeth intentions or cavities 11 formed therein, to facilitate formation of the desired teeth 12 on the bottom surface 8 of the food conveyor belt 6.

As shown in FIG. 2, during the second pass manufacturing process, the flat sheet 3 is first feed onto an exterior surface of a (cylindrical) feed roller 7′ with the top (food carrying) surface of the flat sheet 3 directly engaged against the feed roller 7′ while the rear surface of the flat sheet 3 faces away from the feed roller 7′. Thereafter, one or more cord(s) 4 is/are introduced and trained, in a spaced apart relationship to one another, on the exposed rear surface of the flat sheet 3 prior to these components being processed further. Preferably, each one of the one or more cord(s) 4 are each arranged parallel to one another and a longitudinal axis of the flat sheet 3 in order to resist and prevent any elongation of the flat sheet 3 during use.

Next, the flat sheet 3 with the one or more cord(s) 4 trained on the rear surface thereof are then fed toward one or more (optional) heaters 5 which heat the one or more cord(s) 4 and the flat sheet 3 in order to facilitate adhesion of those components to a bottom layer 8 which is to be subsequently formed, as discussed below in further detail. The heating element(s) of the heaters 5 is/are typically spaced between 0.050 inches and 2 inches from the outer surface of the feed roller 7′ and typically operate at a temperature of between 500 and 1,500 degrees Fahrenheit. The heaters 5 are arranged so as to heat the flat sheet 3 and the one or more cord(s) 4 to a temperature of between 200 and 400 degrees Fahrenheit. If desired, since the heaters 5 are optional, they may be eliminated for some applications. The heated flat sheet 3 and one or more cord(s) 4 are both then fed, by the feed roller 7′, into the nip N′, formed between the feed roller 7′ and a forming mandrel/roller 7, where a layer extruded material 9, which will form the bottom layer 8 of the food conveyor belt 6, is supplied by a die nozzle 1′.

The supplied bottom layer material 9 may be, for example, a urethane or a co-polyester resin in either liquid or molten form. The urethane or co-polyester resin is typically discharged, from the die nozzle 1, 1′, at a temperature of between 350 and 600 degrees Fahrenheit. This bottom layer material 9 is extruded at a sufficient flow rate and in a sufficient quantity so as to fill the nip N′ and separate and space the one or more cord(s) 4 and the rear surface of the flat sheet 3 away from the forming mandrel/roller 2, 7 and fill that space. The outwardly facing surface of the feed roller 2′, 7′ is typically spaced from the outwardly facing surface of the forming mandrel/roller 2, 7 by a distance of between 0.020 inches and 0.50 inches so that the (second) nip N′ normally has a width or gap of between 0.020 inches and 0.50 inches. One or both of the feed roller 2′, 7′ and the forming mandrel/roller 2, 7 are controlled to a temperature of between 50 and 250 degrees Fahrenheit to assist with cooling and formation of the bottom layer 8.

An exterior surface of the forming mandrel roller 2, 7 typically has a plurality of teeth indentations or cavities 11 formed therein which facilitate the formation of a plurality of teeth 12 in the outwardly facing (rear) surface of the bottom layer 8 which is being fabricated. The adjacent teeth 12 of the forming mandrel/roller 7 are typically spaced from one another by a distance of between 0.50 inches and 4 inches, and typically each tooth has a width of between 0.02 inches and 1 inch and a depth of between 0.02 inches and 1 inch.

The formed food conveyor belt 6 is then transferred from the forming mandrel/roller 7 to a transfer roller 7″ and finally the formed food conveyor belt 6 is released from the transfer roller 7″ and then collected, wound and stored for further processing (not shown), e.g., the formed food conveyor belt 6 is wound up on a conventional winder for subsequent processing thereof. Thereafter, the formed food conveyor belt 6 may then be cut to a desired length, installed on a desired piece of conveyor equipment and the adjacent ends spliced together to form an endless belt.

The (first) feed roller 7′, the (second) forming mandrel/roller 7 and the transfer roller 7″ each have a diameter of about 16 inches or so and rotate at a rotation speed of between 10 and 200 inches per minute during manufacture of flat sheet 3 and the food conveyor belt 6.

Each roller apparatus 13, 14 comprises: 1) the first (feed) roller 2′, 7′, 2) the second (mandrel) rollers 2, 7 and 3) the transfer roller 2″, 7″. It is to be appreciated that the open-ended food conveyor belt may be manufactured by the first manufacturing pass (see FIG. 1) which is subsequently followed by the second manufacturing pass (see FIG. 2) on one and the same single roller apparatus 13 or 14, with a possible exchange of the second (mandrel) roller 2 with the second (mandrel) roller 7. Alternatively, the flat sheet 3 may be first manufactured, during the first manufacturing pass, on a first roller apparatus 13, while both the bottom sheet 8 and the resulting open-ended food conveyor belt 6 can be manufactured, during the second manufacturing pass, on a second, substantially similar and sequentially arranged, roller apparatus 14, as shown in FIG. 3. It is to be appreciated that one or more rollers 15, 16 may assist with conveying the flat sheet 3 from the first roller apparatus 13 to the second, substantially similar and sequentially arranged, roller apparatus 14. In addition, it is to be appreciated that one or more rollers 17 may assist with conveying the at least one cord(s) 4 on to the rear surface of the flat sheet 3.

While various embodiments of the present invention have been described in detail, it is apparent that various modifications and alterations of those embodiments will occur to and be readily apparent to those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. In addition, it is to be understood that the phraseology and terminology used herein is for the purpose of description and should not be regarded as limiting. The use of “including,” “comprising,” or “having,” and variations thereof herein, is meant to encompass the items listed thereafter and equivalents thereof as well as additional items while only the terms “consisting of” and “consisting only of” are to be construed in a limitative sense.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

I claim:

1. A method of making an open-ended food conveyor belt comprising two or more layers of different elastomers.

2. The method of claim 1 by training a previously extruded flat sheet or layer on a first portion of a smooth, rotating, cylindrical mandrel, said first portion including a first cavity defined between said smooth mandrel or a steel band and a profiled, rotating mandrel; training tension cords that may or not be coated for bonding purposes in a machine direction and extruding a top layer of polymer and metering the top layer of polymer into said first cavity or into said first gap; thereby forming a profiled belt with one or more resin grade surfaces.

3. The method of claim 1 wherein said smooth mandrel is used in said single apparatus for one of said two passes and said smooth mandrel is replaced by said profiled mandrel in said single apparatus for the second of said two passes.

4. The method of claim 1 wherein said top layer material and said profile layer material both comprise thermoplastic elastomer or thermoplastic polyurethane.

5. The method of claim 1 wherein the belt is manufactured in tandem fashion using two different extruders and two sets of sequentially arranged rollers.

6. A method of making an open-ended, layered flat belt comprising:
training elastomeric matrix on a first portion of a smooth, rotating, cylindrical mandrel, said first portion including a first cavity defined between said smooth mandrel and a molding band or a first gap defined between said smooth mandrel and a second smooth roller; training tension cords that may or may not be coated for bonding purposes in the machine direction and extruding a top layer material onto the first layer and metering it into said first cavity or into said first gap; thereby forming a belt comprising a film of said top layer material.

7. The method of claim 6 wherein said method comprises two passes through a single apparatus comprising said smooth mandrel and said molding band or said laminating roller.

8. The method of claim 6 by training a previously extruded flat layer on a first portion of a smooth, rotating, cylindrical mandrel, said first portion including a first cavity defined between said smooth mandrel or a steel band and a smooth, rotating mandrel; training tension cords in the machine direction and extruding a top layer of a different polymer and metering it into said first cavity or into said first gap; thereby forming a belt with two or more resin grade surfaces.

9. The method of claim 6 wherein said top layer material and said profile layer material both comprise thermoplastic elastomer or thermoplastic polyurethane.

10. The method of claim 6 where the belt is manufactured in tandem fashion using two different extruders.

11. The method of claim 6 wherein said method comprises two passes through a single apparatus comprising said molding band and smooth, rotating, cylindrical mandrel.

12. A method of manufacturing an open-ended food conveyor belt comprising two or more layers of different elastomers, the method comprising:
forming a flat sheet during a first manufacturing process;
during a second manufacturing process, training at least one cord on a rear surface of the flat sheet of a feed roller;
discharging an extruded material into a nip such that the extruded material sandwiches the at least one cord between a rear surface of the flat sheet and a bottom surface to be formed; and
after formation of the bottom surface, collecting the open-ended food conveyor belt.

13. The method of claim 12, further comprising, during formation of the bottom surface, forming a plurality of teeth in a rear surface of the bottom surface which have a desired belt pitch.

14. The method of claim 13, further comprising spacing adjacent teeth from one another by a distance of between 0.50 inches and 5 inches, and forming each tooth with a width of between 0.0625 inches and 1 inch and a depth of between 0.125 inches and 2 inches.

15. The method of claim 12, further comprising manufacturing the flat sheet from a urethane resin having a Shore A hardness of between 85 and 98.

16. The method of claim 12, further comprising the step of heating a rear surface of the flat sheet and the at least one cord, trained on the rear surface thereof, with at least one heater, prior to entering the nip, to facilitate adhesion of the flat sheet and the at least one cord to the bottom layer, and spacing with the at least one heater between 0.020 inches and 4 inches from an outer surface of the feed roller.

17. The method of claim 12, further comprising the step of dispensing one of a urethane or a co-polyester resin, from a die nozzle into the nip, for forming the bottom surface of the open-ended food conveyor belt.

18. The method of claim 12 wherein the flat sheet material and the bottom surface each comprise one of a thermoplastic elastomer and thermoplastic polyurethane.

19. The method of claim 12, further comprising the step of manufacturing the flat sheet and the open-ended food conveyor belt on a single apparatus, with the flat sheet being manufactured first followed by subsequent manufacture of the open-ended food conveyor belt on the same single apparatus.

20. The method of claim 12, further comprising the step of using a smooth mandrel, in the single apparatus, to manufacture the flat sheet, and subsequently replacing the smooth mandrel, in the single apparatus, with a profiled mandrel in order to manufacture the open-ended food conveyor belt, and
training a plurality of cords on the rear surface of the flat sheet with each of the cords being spaced from one another.
